(19) United States
(12) Patent Application Publication
(10) Pub. No.: US 2013/0090057 A1
(43) Pub. Date: Apr. 11, 2013

(54) System And Method For Validating A Detachable Antenna

(71) Applicants: Michael R. Green, Needham, MA (US); William J. McFarland, Los Altos, CA (US)

(72) Inventors: Michael R. Green, Needham, MA (US); William J. McFarland, Los Altos, CA (US)

(73) Assignee: Qualcomm Atheros, Inc., San Jose, CA (US)

(21) Appl. No.: 13/269,063

(22) Filed: Oct. 7, 2011

(51) Int. Cl. H04W 92/12; H04W 12/06; H04B 5/00

(52) U.S. Cl. 455/26.1; 455/90.2; 455/41.1

(57) ABSTRACT

The present application describes a system and method for validating a detachable antenna which may include, coupling a detachable antenna to a wireless device, providing an antenna identification code of the detachable antenna to the wireless device, determining if the antenna identification code of the detachable antenna is a valid antenna identification code for the wireless device and enabling operation of the wireless device if the antenna identification code of the detachable antenna is a valid antenna identification code for the wireless device. The operation of the wireless device may additionally be disabled if it is subsequently determined that the detachable antenna connected to the wireless device is no longer a valid antenna or if it is determined that the detachable antenna has been previously used by another wireless device.

### TECHNICAL FIELD

The present application relates generally to wireless networking systems utilizing detachable antennas, and more particularly to systems and methods to determine if a detachable antenna is a valid antenna for use with a particular wireless networking device.

### BACKGROUND

Wireless devices, such as wireless access points and wireless routers, are commonly equipped with detachable antennas for the wireless transmission and reception of radio frequency signals in a wireless networking system. Detachable antennas allow the wireless access points to be customized to provide specific performance characteristics and to accommodate various conditions that may be dependent upon a given regulatory domain. The antenna of a wireless access point may be removed and replaced with a detachable antenna having a higher gain to improve the transmission of the wireless access point. Additionally, detachable antennas allow for the replacement of broken or damaged antennas without requiring the replacement of the entire wireless device.

While there are benefits to detachable antennas, the Federal Communications Commission's (FCC) regulations may prohibit the use of a particular antenna with a specific wireless device if the combination of the antenna gain and the transmission output power of the wireless device exceeds the maximum transmit power allowable by FCC regulations in a given regulatory domain. As such, the FCC may seek positive validation that only authorized antennas are used with FCC certified wireless devices. In addition, attaching a detachable antenna to a wireless access point that has a mismatched impedance may reduce the overall gain of the wireless access point transmission due to mismatch loss. It is therefore desirable to prevent the attachment of a detachable antenna to wireless device if the detachable antenna is not an approved antenna for the wireless device.

Thus, there is a need for a system and method that provides validation that only authorized detachable antennas are used with a specific wireless device.

### SUMMARY

The present application describes a system and method for validating a detachable antenna for use with a wireless device, such as a wireless access point.

A method is provided for validating a detachable antenna which may include, coupling a detachable antenna to a wireless device, providing an antenna identification code of the detachable antenna to the wireless device, determining if the antenna identification code of the detachable antenna is a valid antenna identification code for the wireless device and enabling operation of the wireless device if the antenna identification code of the detachable antenna is a valid antenna identification code for the wireless device. The operation of the wireless device may additionally be disabled if it is subsequently determined that the detachable antenna connected to the wireless device is no longer a valid antenna or if it is determined that the detachable antenna has been previously used by another wireless device and as such is invalid for use with another wireless device.

The antenna identification code may be provided to the wireless device by connecting the detachable antenna to the wireless device and transmitting the antenna identification code from a near field communication (NFC) target device of the detachable antenna to an NFC initiator device of the wireless device. Alternatively, the antenna identification code may be physically printed on the detachable antenna and the antenna identification code may be manually provided to the wireless device utilizing a user interface of the wireless device.

A system is provided for validating a detachable antenna for use with a wireless device. The system may include, a detachable antenna comprising an antenna identification code and a wireless device comprising a controller, the controller to enable operation of the wireless device if the antenna identification code of the detachable antenna is a valid antenna identification code for the wireless device.

In a particular embodiment, the detachable antenna may include a near field communication (NFC) target device comprising the antenna identification code of the detachable antenna and the wireless device may include a near field communication (NFC) initiator device coupled to the controller of the wireless device.

In an additional embodiment, the detachable antenna may include a user interface coupled to the controller. The user interface for manually providing the antenna identification code of the detachable antenna to the wireless device for validation of the detachable antenna.

An increased level of validation for the detachable antenna may be provided through the use of a centralized database of authorized antenna identifications codes for the wireless device and alternatively, through the use of a certification authority accessible to the wireless device.

### BRIEF DESCRIPTION OF THE DRAWINGS

FIG. 1 is a flow diagram illustrating a method for validating a detachable antenna for use with a wireless device.

FIG. 2 is a flow diagram illustrating a method for validating a detachable antenna for use with a wireless device utilizing a near field communication device.

FIG. 3 is a flow diagram illustrating a method for validating a detachable antenna for use with a wireless device utilizing a user interface of the wireless device.

FIG. 4 is a flow diagram illustrating a method for verifying that a validated detachable antenna has not been previously used by another wireless device.

FIG. 5 is a block diagram illustrating a system for validating a detachable antenna for use with a wireless device.

### DETAILED DESCRIPTION

Those of ordinary skill in the art will realize that the following detailed description of embodiments in this specification is illustrative only, and is not intended to be in any way limiting. Other embodiments will readily suggest themselves to such skilled persons having the benefit of this disclosure. It will be apparent to one skilled in the art that these specific details may not be required to practice the embodiments. In other instances, well-known devices are shown in block diagram form to avoid obscuring the present application. In the following description of the embodiments, substantially the same parts are denoted by the same reference numerals.

It is desirable to have the ability to replace the antenna of a wireless device with a different antenna to modify the transmission parameters of the wireless device to accommodate various networking conditions, such as to increase or reduce the overall gain of the wireless device. In addition, it is desirable to be able to replace a defective antenna with a new antenna, thereby repairing the wireless device and avoiding the need to repair the antenna or replace the entire wireless device. However, it is also desirable to have the ability to control which antennas are used with a particular wireless device. FCC regulations may limit the allowable gain within a communication system and it is therefore desirable to prevent the replacement of antennas in a wireless device in which the allowable gain may be exceeded.

Functionality can be introduced into the detachable antenna and the wireless device to require validation of a detachable antenna that is coupled to the wireless device prior to the wireless device being enabled to transmit and receive signals on the wireless network.

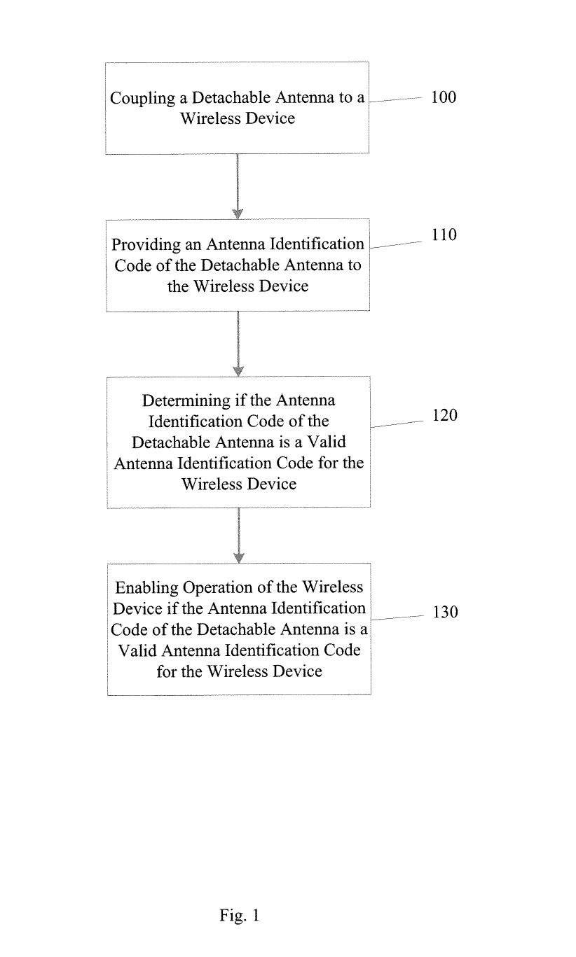

With reference to the flow diagram illustrated in FIG. 1, a method for validating a detachable antenna includes, coupling a detachable antenna to a wireless device 100, providing an antenna identification code of the detachable antenna to the wireless device 110, deter mining if the antenna identification code of the detachable antenna is a valid antenna identification code for the wireless device 120 and enabling operation of the wireless device if the antenna identification code of the detachable antenna is a valid antenna identification code for the wireless device 130. As such, a method is provided for validating a detachable antenna coupled to a wireless device prior to enabling the wireless device for the transmission and reception of wireless signals.

Various methods are envisioned for providing the antenna identification code of the detachable antenna to the wireless device. In one embodiment, the antenna identification code may be provided to the wireless device utilizing a near field communication (NFC) device. In another embodiment, the antenna identification code may be provided to the wireless device utilizing a user interface of the wireless device.

In a particular embodiment, the detachable antenna may include a near field communication (NFC) target device and the wireless device may include a near field communication (NFC) initiator device. Near field communication (NFC) devices include short-range wireless technologies, typically requiring a distance between devices of 4 cm or less to establish a communication link. NFC is a contactless technology utilizing magnetic induction between two loop antennas located within each other's near field. NFC operates within the unlicensed radio frequency ISM band of 13.56 MHz. Theoretical working distances of NFC devices utilizing standard antennas is up to 20 cm, however practical working distances are typically approximately 4 cm or less.

NFC devices may operate in either a passive or active communication mode. In a passive communication mode, with the target device and the initiator device placed within close proximity of each other, the initiator device may provide a carrier field and the target device may answer by modulating the carrier field. Additionally, in the passive NFC mode, the initiator device may actively generate a radio frequency field that is effective in powering the passive target device, thus enabling the NFC target device to be embodied in a simple form such as a tag, sticker, key fob or card that does not require a battery or other independent source of power. In a particular embodiment, the passive NFC target device may be a radio frequency identification (RFID) tag. In an active communication mode, both the initiator device and the target device may communicate by alternately generating their own carrier fields. In the active NFC mode, both the initiator device and the target device may have their own source of power.

The NFC target device may be embedded in the housing of the detachable antenna and may be positioned in close proximity to the end of the detachable antenna comprising the antenna connector. In addition, the wireless device may include an NFC initiator device which may be positioned in close proximity to the external antenna connector of the wireless device. In this embodiment, when the detachable antenna is coupled to the wireless device, the NFC target device and the NFC initiator device are positioned within close enough proximity of each other to establish a communication link. The NFC target device embedded within the housing of the antenna may be a passive NFC target device and the NFC initiator device within the wireless device may provide a source of power effective in powering the passive NFC target device. The NFC initiator device may provide power to the NFC target device by transmitting an NFC radio frequency communication signal through a wired connection established when the detachable antenna is coupled to the wireless device. After the NFC initiator powers-up the NFC target device, the NFC target device may provide an antenna identification code of the detachable antenna to the NFC initiator of the wireless device. The wireless device may then determine if the antenna identification code of the detachable antenna is a valid antenna identification code for the wireless device. Various methods for validating NFC data are known in the art and are within the scope of the present invention.

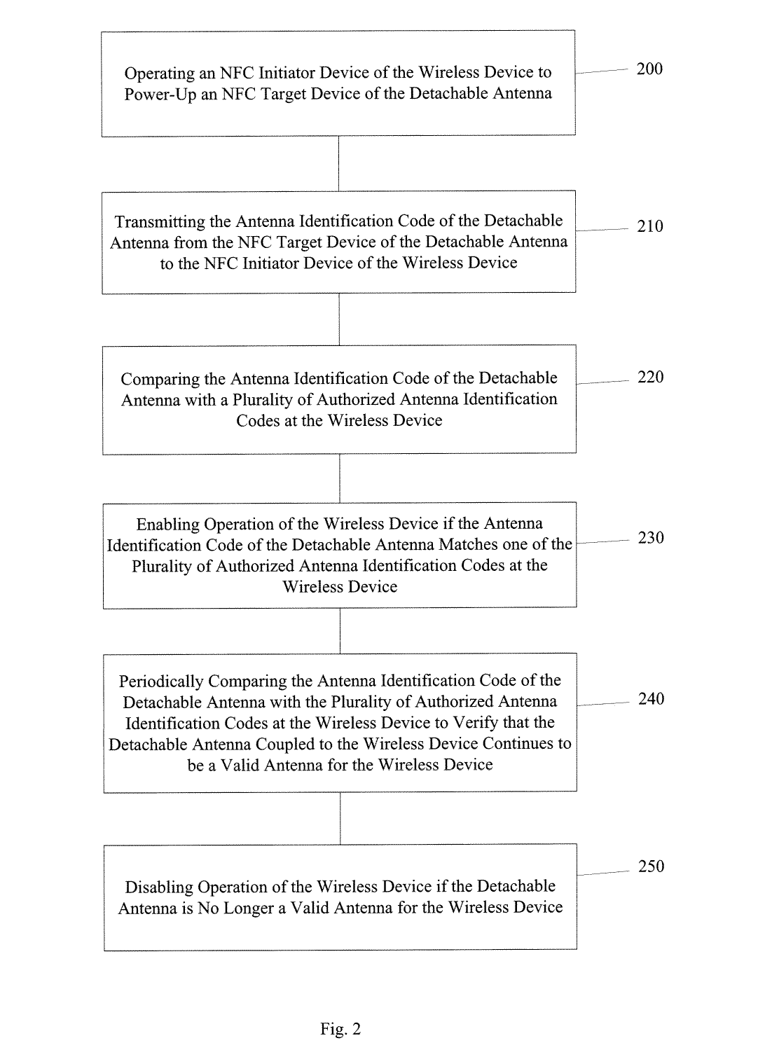

With reference to the flow diagram illustrated in FIG. 2, a method for validating a detachable antenna having an NFC target device coupled to a wireless device having an NFC initiator device may begin by operating the NFC initiator device of the wireless device to power-up the NFC target device of the detachable antenna 200. After the NFC target device has been powered-up, the NFC target device may transmit an antenna identification code stored within the NFC target device to the NFC initiator device of the wireless device 210. Upon receipt of the antenna identification code from the detachable antenna, the wireless device may determine if the antenna identification code of the detachable antenna is a valid antenna identification code for the wireless device. In a particular embodiment, the wireless device determines if the antenna identification code is a valid antenna identification code for the wireless device by comparing the antenna identification code of the detachable antenna with a plurality of authorized antenna identification codes stored at the wireless device 220. If the antenna identification code of the detachable antenna transmitted by the NFC target device to the NFC initiator device matches one of the plurality of authorized antenna identification codes stored at the wireless device, the wireless device is enabled to operate 230. The wireless device may then utilize the detachable antenna to transmit and receive signals across the wireless network.

An additional level of security may be provided by establishing a secure transmission channel between the NFC initiator device and the NFC target device. Encryption and authentication algorithms are well known in the art to be utilized with an NFC communication system for the establishment of a secure transmission channel. The NFC target device may transmit an antenna identification code to the NFC initiator device of the wireless device utilizing encryption or authentication methods known in art to provide an additional level of security for validation of the detachable antenna.

To prevent a user from removing a detachable antenna that has been validated and replacing it with another detachable antenna that is not approved for the wireless device, the wireless device may periodically compare the antenna identification code of the detachable antenna with the plurality of authorized antenna codes stored at the wireless device to verify that the detachable antenna coupled to the wireless device continues to be a valid antenna for the wireless device 240. The process of periodically querying the antenna identification code to verify the validity of the detachable antenna may be performed across the radio frequency cable connecting the wireless device to the detachable antenna, without the need for the NFC device. Additionally, the wireless device may perform the query repeatedly and on a regular schedule, perhaps once per minute, to verify the continued validity of the connected antenna. If the wireless device determines that the detachable antenna that is coupled to the wireless device is no longer a valid antenna for the wireless device, the operation of the wireless device may be disabled 250, thereby preventing an unauthorized antenna from being attached to the wireless device after an authorized antenna has been removed.

In order to accommodate future detachable antenna models that may be authorized for use with the wireless device, the antenna identification codes stored at the wireless device may be upgraded to included additional valid antenna models for the wireless device. In a particular embodiment, the antenna identification codes at the wireless device may be upgraded automatically via an internet connection to the wireless device manufacturer's website. Alternatively, the antenna identification codes may be updated manually through a user interface of the wireless device.

In an additional embodiment, the antenna identification code of the detachable antenna may be provided to the wireless device through a user interface associated with the wireless device. In this embodiment, a detachable antenna may be labeled with an antenna identification code that is unique to that particular detachable antenna. The antenna identification code may be a unique encrypted key that is provided by the original manufacturer of the antenna. In this embodiment, the antenna identification code is provided to the wireless device manually, wherein a user may enter the antenna identification code of the detachable antenna into the wireless device via a user interface of the wireless device. Application software to implement a user interface for the wireless device, such as a wireless access point, is known in the art to allow a user to manually adjust the settings of the wireless device. After the user has manually entered the antenna identification code of the detachable antenna into the user interface of the wireless device, the wireless device may then determine if the antenna identification code of the detachable antenna is a valid antenna identification code for the wireless device. Various methods for validating encrypted data are known in the art and are within the scope of the present invention.

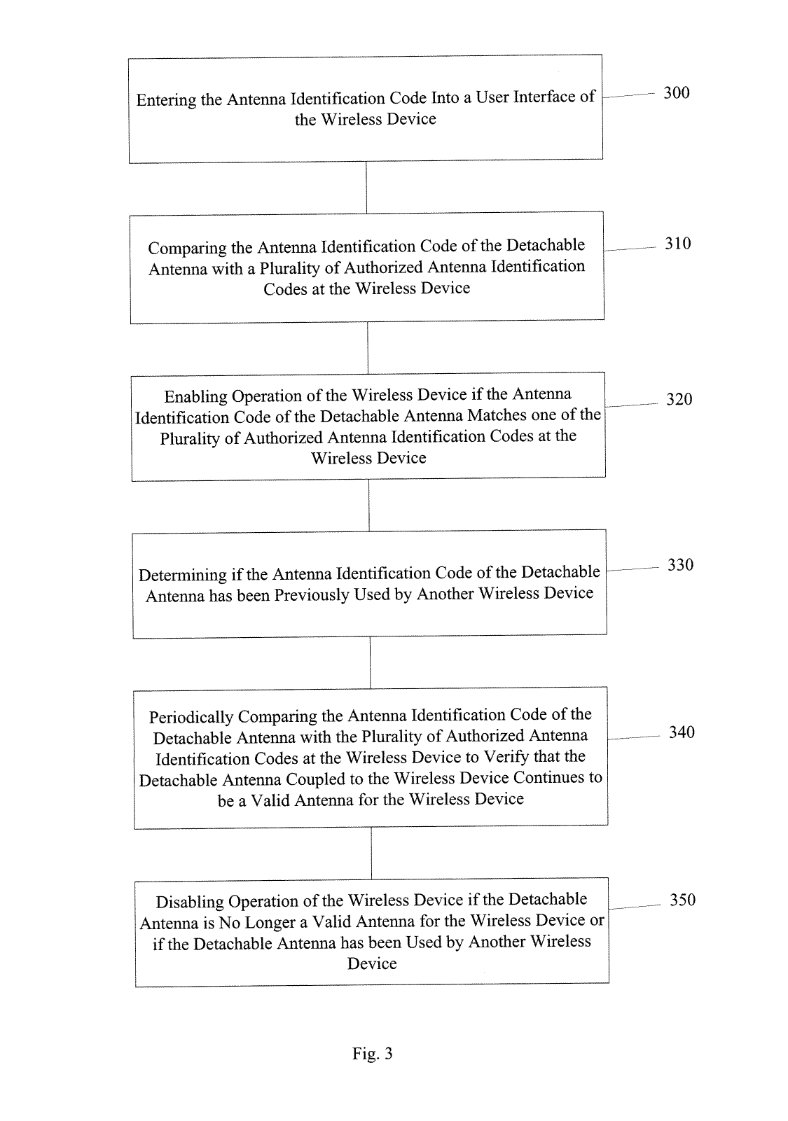

With reference to the flow diagram illustrated in FIG. 3, a method for validating a detachable antenna may begin by entering the antenna identification code of the detachable antenna into the user interface of the wireless device 300. The antenna identification code of the detachable antenna is then compared against a plurality of authorized antenna identification codes stored at the wireless device 310. If the antenna identification code matches one of the plurality of authorized antenna identification codes stored at the wireless device, the wireless device may be enabled 320 and the wireless device may begin transmitting and receiving wireless signals utilizing the validated antenna.

While utilizing a user interface of the wireless device to enter a unique antenna identification code for the detachable antenna provides a first level of validation for the detachable antenna, utilizing a user interface to enter the antenna identification code may not prevent a user from utilizing an antenna identification code that has already been used by another wireless device to validate a detachable antenna coupled to the wireless device. In other words, a user could potentially couple any detachable antenna to the wireless device and then enter an antenna identification code from a different detachable antenna that is authorized for the wireless device into the user interface of the wireless device, thereby circumventing the first level of validation for the detachable antenna. To prevent a user from circumventing the validation process, a second level of validation can be implemented.

In a second level of validation, after the wireless device is enabled by a user entering a valid antenna identification code into the user interface of the wireless device, it is then determined whether or not the antenna identification code of the detachable antenna has been previously used by another wireless device 330. In one embodiment for determining whether or not the antenna identification code has been previously used by another wireless device 330, the wireless device may establish a connection with a centralized database of authorized antenna identification codes. The centralized database of authorized antenna identification codes may reside on the internet and may include a plurality of antenna identification codes authorized for the wireless device and a status identifier for each of the antenna identification to identify each of the antenna identification codes as either unused or previously used by another wireless device. The wireless device may compare the antenna identification code of the detachable antenna with the centralized database of authorized antenna identification codes to determine if the antenna identification code entered by the user has been previously used by another wireless device. If the wireless device determines that the antenna identification code entered by the user has been previously used by another wireless device, the operation of the wireless device may be disabled.

Additionally, it is envisioned that the status identifiers of the centralized database of authorized antenna identification codes can be reset to allow for a detachable antenna to be validated for another wireless device if the prior wireless device is no longer using the detachable antenna.

In another embodiment for determining whether or not the antenna identification code has been previously used by another wireless device 330, the wireless device may utilize a digital certificate associated with the antenna identification code of the detachable antenna. The digital certificates may be supplied by the manufacturer of the wireless device and may be certified by a certification authority. Upon initial startup of the wireless device, a leniency period may be provided in which the detachable antenna that is coupled to the wireless device is assumed to be a valid antenna and validation of the antenna is not required. After the initial leniency period, the wireless device may request that the user enter the antenna identification code of the detachable antenna into the user interface of the wireless device. The wireless device may then compare the antenna identification code entered by the user with the plurality of authorized antenna identification codes stored at the wireless device and the wireless device may validate the antenna and enable continued operation of the wireless device if the antenna identification code matches one of the authorized antenna identification codes of the wireless device. The wireless device may then identify the digital certificate associated with the antenna identification code of the detachable antenna and use the identified digital certificate to validate the detachable antenna through an established connection with a certification authority. The certification authority may be responsible for issuing and revoking digital certificates for the wireless device, such that only one digital certificate is available to be issued for any one detachable antenna. In a particular embodiment, the certification authority may be the website of the wireless device manufacturer. In an additional embodiment, the certification authority may be an independent certification authority accessible over the internet. The wireless device may provide the digital certificate associated with the antenna identification code to the certification authority and the certification authority may validate the certificate if the certification authority determines that the antenna identification code of the detachable antenna has not been previously used by another wireless device. Digital certificates may expire and the wireless device may regularly query the certification authority to update its digital certificates. Additionally, as new detachable antennas are authorized for the wireless device, the digital certificates of the wireless device may be periodically updated by the certification authority to accommodate new antenna models and associated antenna identification codes that became available after the wireless device was introduced to the market.

This second level of validation may be used to determine if an antenna identification code entered into the user interface by the user has been used by another wireless device and if it is determined that the antenna identification code has been used before, the wireless device may be disabled. This second level of validation may prevent users from circumventing the validation of the detachable antenna by entering an antenna identification code of a different detachable antenna than the one currently coupled to the wireless device. If it is determined that the antenna identification code entered by the user has been previously used by another wireless device, the operation of the wireless device may be disabled.

In addition to disabling the wireless device if it is determined that the antenna identification code has been previously used by another wireless device, it may also be desirable to prevent a user from removing a detachable antenna that has been validated utilizing a centralized database of authorized identification codes or a digital certificate and a certification authority and replacing it with a detachable antenna that is not approved for the wireless device. To prevent a user from removing a detachable antenna after the antenna has been validated and replacing it with an unauthorized antenna, the wireless device may periodically compare the antenna identification code entered by the user with the plurality of authorized antenna codes stored at the wireless device to verify that the detachable antenna coupled to the wireless device continues to be a valid antenna for the wireless device 340. The wireless device may perform the query repeatedly and on a regular schedule, perhaps once per minute, to verify the continued validity of the connected antenna. If the wireless device determines that the detachable antenna that is coupled to the wireless device is no longer a valid antenna for the wireless device, the operation of the wireless device may be disabled 350, thereby preventing an unauthorized antenna from being attached to the wireless device after a validated antenna has been removed.

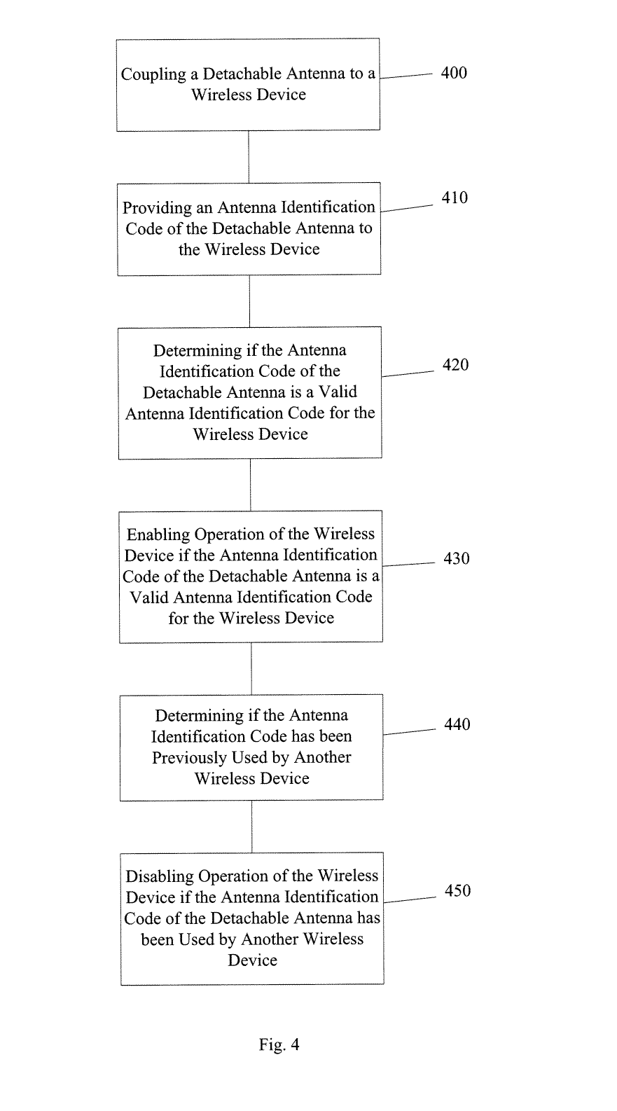

With reference to FIG. 4, a method for validating a detachable antenna utilizing both a first level and second level verification includes, coupling a detachable antenna to a wireless device 400. The antenna identification code of the detachable antenna is then provided to the wireless device 410. The antenna identification code may be provided through the use of an NFC device or through a user interface. The wireless device then determines if the antenna identification code of the detachable device is a valid antenna identification code for the wireless device 420. If the wireless device determines that the detachable is a valid antenna, the operation of the wireless device is enabled 430. The wireless device then determines if the antenna identification code of the detachable antenna has been previously used by another wireless device 440. If the wireless device determines that the antenna identification code has been previously used with another wireless device, the operation of the wireless device is disabled 450.

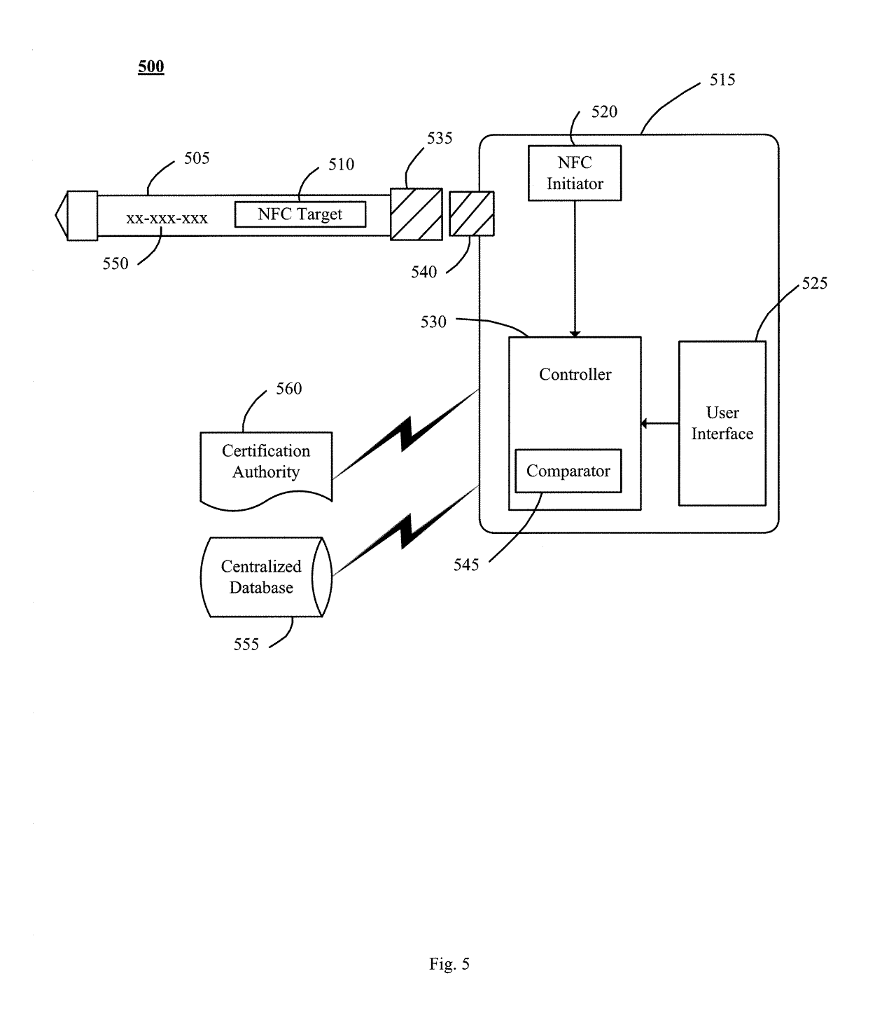

With reference to FIG. 5, a system 500 for validating a detachable antenna may include a detachable antenna 505 comprising an antenna identification code and a wireless device 515 comprising a controller 530, wherein the controller enables operation of the wireless device 515 if the antenna identification code of the detachable antenna 505 is a valid antenna identification code for the wireless device 515. In a particular embodiment, the wireless device 515 is a wireless access point however, this is not intended to be limiting and other wireless devices, such as wireless routers and cellular telephones are within the scope of the present invention.

The wireless device 515 may include a near field communication (NFC) initiator device 520 and the detachable antenna 505 may include a near field communication (NFC) target device 510 which comprises the antenna identification code. The NFC target device 510 may be supplied by the manufacturer of the detachable antenna 505. Additionally, the NFC initiator device 520 may be supplied by the manufacturer of the wireless device 515. The NFC target device 510 may be positioned within the housing of the detachable antenna 505 and located in close proximity to the connector 535 of the detachable antenna 505. The NFC initiator device 520 of the wireless device may be located within close proximity to the connector 540 of the wireless device. With the NFC devices located within close proximity to their respective connectors, when the detachable antenna 505 is coupled to the wireless device 515 the distance between the NFC target device 510 and the NFC initiator device 520 may be sufficiently small to allow for the establishment of a communication link between the NFC devices. In a particular embodiment, the distance between the NFC target device 510 and the NFC initiator device 520 is less than about 4 cm. With the NFC target device 510 and the NFC initiator device 520 coupled to each other, a communication link can be established between the NFC target device 510 and the NFC initiator device 520 and the antenna identification code of the detachable antenna 505 can be transmitted from the NFC target device 510 to the NFC initiator device 520 of the wireless device 515. Additionally, the NFC initiator device 520 may provide a source of power for the NFC target device 510 when the NFC devices are positioned within close proximity.

In a specific embodiment, the wireless device may further comprise a controller 530 coupled to the NFC initiator device 520 to receive the antenna identification code of the detachable antenna 505 communicated from the NFC target device 510 to the NFC initiator device 520. The controller 530 may enable operation of the wireless device 515 if the antenna identification code of the detachable antenna 505 is a valid antenna identification code for the wireless device 515. To determine if the antenna identification code is a valid identification code for the wireless device 515, the controller may include a comparator 545. The comparator 545 may compare the antenna identification code supplied by the NFC target device 510 of the detachable antenna 505 with a plurality of authorized antenna identification codes at the wireless device 515 to determine if the antenna identification code supplied by the NFC target device 510 of the detachable antenna 505 matches one of the authorized antenna identification codes at the wireless device 515. If the antenna identification code supplied by the NFC target device 510 of the detachable antenna 505 matches one of the authorized antenna identification codes at the wireless device 515 it may be determined that the antenna identification code is a valid antenna identification code for the wireless device 515 and the controller 530 may enable operation of the wireless device 515. If the identification code supplied by the NFC target device 510 of the detachable antenna 505 does not match one of the authorized antenna identification codes at the wireless device 515 it may be determined that the antenna identification code is not a valid antenna identification code for the wireless device 515 and the controller 530 may not enable operation of the wireless device 515.

Upon verification that the detachable antenna 505 coupled to the wireless device 515 is an authorized antenna for the wireless device 515, the controller 530 may be operated to periodically verify that the antenna identification code of the NFC target device 510 continues to be a valid antenna identification code to ensure that the authorized antenna has not been removed and replaced with an unauthorized antenna. This periodic comparison may occur within the physical connection established between the coupling of the connector 535 of the detachable antenna 505 and the connector 540 of the wireless device 515.

In an additional embodiment, the detachable antenna 505 may include the antenna identification code physically printed on the detachable antenna 505 or printed on a label attached to the detachable antenna 505. The physical antenna identification code 550 may be provided by the manufacturer of the detachable antenna 505. With this embodiment, the wireless device 515 may further comprise a user interface 525. The user interface 525 may be accessed by a user to manually enter the antenna identification code 550 shown on the detachable antenna into the application software of the wireless device 515. The comparator 545 of the controller 530 may then compare the antenna identification code supplied by the user interface 525 with a plurality of authorized antenna identification codes at the wireless device 515 to determine if the antenna identification code supplied by user interface 525 matches one of the authorized antenna identification codes at the wireless device 515. If the antenna identification code supplied by the user interface 525 matches one of the authorized antenna identification codes at the wireless device 515 it may be determined that the antenna identification code is a valid antenna identification code for the wireless device 515 and the controller 530 may enable operation of the wireless device 515. If the identification code supplied by the user interface 525 does not match one of the authorized antenna identification codes at the wireless device 515 it may be determined that the antenna identification code is not a valid antenna identification code for the wireless device 515 and the controller 530 may not enable operation of the wireless device 515.

To provide an additional level of security against the duplicate use of physical antenna identification codes, thereby circumventing the validation process of the detachable antenna 505, the system may include a centralized database of authorized antenna identification codes 555 accessible by the wireless device 515. In one embodiment, the centralized database of authorized antenna identification codes 555 may reside on the internet and in a specific embodiment, the centralized database of authorized antenna identification codes 555 may reside on an internet website maintained by the manufacturer of the wireless device 515. An additional level of security is provided as a result of the authorized antenna identification codes being stored in a centralized location that may be accessible by many wireless devices. The centralized database of authorized antenna identification codes 555 may include a plurality of authorized antenna identification codes for the wireless device 515 and may additionally include a status identifier for each of the authorized antenna identification codes, wherein the status identifier identifies each of the plurality of authorized antenna identification codes as being unused or previously used by another wireless device. Upon a comparison between the antenna identification code 550 provided by the user through the user interface 525 of the wireless device 515 and the status identifier associated with the antenna identification code stored in the centralized database of authorized antenna identification codes 555, the controller 530 of the wireless device 515 may determine that the antenna identification code provided by the user has been previously used by another wireless device. If the controller 530 determines that the antenna identification code has been previously used by another wireless device, the controller may disable the operation of the wireless device 515. As such, the centralized database of authorized antenna identification codes 555 prevents a user from using the physical authorized antenna identification code 550 of the detachable antenna 505 with more than one wireless device 515 by disabling operation of the wireless device 515 if it is determined that the authorized identification code has been previously used by another wireless device.

In an additional embodiment providing an additional level of security against the duplicate use of physical antenna identification codes, thereby circumventing the validation process of the detachable antenna 505, the system may include a certification authority 560 accessible by the wireless device. The certification authority 560 may be responsible for issuing and revoking digital certificates for the wireless device 515, such that only one digital certificate is available to be issued for any one detachable antenna. In a particular embodiment, the certification authority 560 may be the website of the wireless device manufacturer. In an additional embodiment, the certification authority 560 may be an independent certification authority on the internet. The wireless device 515 may provide the digital certificate associated with the antenna identification code 550 provided through the user interface 525 to the certification authority 560 and the certification authority 560 may validate the certificate if the certification authority 560 determines that the antenna identification code 550 of the detachable antenna 515 has not been previously used by another wireless device. An additional level of security is provided as a result of the use of a certification authority 560. If the certification authority 560 determines that the antenna identification code 550 has been previously used by another wireless device, the controller may disable the operation of the wireless device 515. As such, the certification authority 560 prevents a user from using the physical authorized antenna identification code 550 of the detachable antenna 505 with more than one wireless device 515 by disabling operation of the wireless device 515 if it is determined that the authorized identification code 550 has been previously used by another wireless device.

Digital certificates may expire and the wireless device 515 may regularly query the certification authority 560 to update its digital certificates. Additionally, as new detachable antennas 505 are authorized for the wireless device 515, the digital certificates of the wireless device 515 may be periodically updated by the certification authority to accommodate new antenna models and associated antenna identification codes that became available after the wireless device 515 was introduced to the market.

As described, the antenna identification code of the detachable antenna 505 may be provided to the wireless device 515 by accessing the antenna identification code stored within an NFC target device 510 of the detachable antenna 505 or by manually entering the antenna identification code 550 physically shown on the detachable antenna 505 into the user interface 525 of the wireless device. It is envisioned that a detachable antenna 505 may include either an NFC target device 510 or a physical antenna identification code 550. Alternatively, the detachable antenna 505 may include both an NFC target device 510 and a physical antenna identification code 550 to allow for the communication of the antenna identification code of the detachable antenna 505 to the wireless device 515 through either the NFC initiator device 520 of the wireless device 515 or through the user interface 525 of the wireless device 525. Incorporating both the NFC target device 510 and the physical antenna identification code 550 into the detachable antenna 505 will allow the detachable antenna to be validated by the wireless device regardless of whether or not the wireless device 515 includes an NFC initiator device 520 or a user interface 525.

The foregoing descriptions of specific embodiments of have been presented for purposes of illustration and description. They are not intended to be exhaustive or to limit the invention to the precise forms disclosed, and obviously many modifications and variations are possible in light of the above teaching. The embodiments were chosen and described in order to best explain the principles and practical applications, to thereby enable others skilled in the art to best utilize the various embodiments with various modifications as are suited to the particular use contemplated. It is intended that the scope be defined by the claims appended hereto and their equivalents.

1. A method for validating a detachable antenna, the method comprising:
coupling a detachable antenna to a wireless device;
providing an antenna identification code of the detachable antenna to the wireless device;
determining if the antenna identification code of the detachable antenna is a valid antenna identification code for the wireless device; and
enabling operation of the wireless device if the antenna identification code of the detachable antenna is a valid antenna identification code for the wireless device.

2. The method of claim 1, wherein providing an antenna identification code of the detachable antenna to the wireless device further comprises, transmitting the antenna identification code from a near field communication (NFC) target device of the detachable antenna to an NFC initiator device of the wireless device.

3. The method of claim 2, further comprising, operating the NFC initiator device of the wireless device to provide a source of power for the NFC target device of the detachable antenna.

4. The method of claim 3, wherein operating the NFC initiator device of the wireless device to provide a source of power for the NFC target device of the detachable antenna further comprises, operating the NFC initiator device of the wireless device to generate a radio frequency field to provide the source of power for the NFC target device.

5. The method of claim 4, wherein the radio frequency field generated by the NFC initiator device is provided to the NFC target device through a wired connection between the wireless device and the detachable antenna.

6. The method of claim 2, further comprising, establishing a secure transmission channel for transmitting the antenna identification code from the NFC target device of the detachable antenna to the NFC initiator device of the wireless device.

7. The method of claim 1, wherein determining if the antenna identification code of the detachable antenna is a valid antenna identification code for the wireless device further comprises, comparing the antenna identification code of the detachable antenna with a plurality of authorized antenna identification codes at the wireless device and determining that the antenna identification code of the detachable antenna is a valid antenna identification code for the wireless device if the antenna identification code of the detachable antenna matches one of the plurality of authorized antenna identification codes.

8. The method of claim 7, further comprising, periodically updating the plurality of authorized antenna identification codes at the wireless device.

9. The method of claim 1, further comprising, after enabling operation of the wireless device:
periodically comparing the antenna identification code of the detachable antenna with the plurality of authorized antenna identification codes of the wireless device to verify that the detachable antenna coupled to the wireless device continues to be a valid antenna for the wireless device; and
disabling operation of the wireless device if the detachable antenna is no longer a valid antenna for the wireless device.

10. The method of claim 1, wherein providing an antenna identification code of the detachable antenna to the wireless device further comprises, entering the antenna identification code of the detachable antenna into a user interface of the wireless device.

11. The method of claim 1, further comprising, after enabling operation of the wireless device:
determining if the antenna identification code of the detachable antenna has been previously used by another wireless device; and
disabling operation of the wireless device if it is determined that the antenna identification code of the detachable antenna has been previously used by another wireless device.

12. The method of claim 11, wherein determining if the antenna identification code of the detachable antenna has been previously used by another wireless device further comprises:
establishing a connection between the wireless device and a centralized database of authorized antenna identification codes, the centralized database of authorized antenna identification codes comprising a plurality of antenna identification codes authorized for the wireless device and a status identifier for each of the antenna identification codes, the status identifier to identify the status of each of the antenna identification codes as unused or previously used by another wireless device; and
comparing the antenna identification code of the detachable antenna with the centralized database of authorized antenna identification codes to determine if the antenna identification code of the detachable antenna has been previously used by another wireless device based on the status identifier.

13. The method of claim 11, wherein determining if the antenna identification code of the detachable antenna has been previously used by another wireless device further comprises:
identifying a digital certificate associated with the antenna identification code of the detachable antenna at the wireless device;
establishing a connection between the wireless device and a certification authority for digital certificates; and
validating the digital certificate associated with the antenna identification code of the detachable antenna at the certification authority if the certification authority determines that the antenna identification code of the detachable antenna has not been previously used by another wireless device.

14. The method of claim 13, further comprising, periodically updating the digital certificates at the wireless device from the certification authority.

15. A method for validating a detachable antenna, the method comprising:
coupling a detachable antenna to a wireless device;
providing an antenna identification code of the detachable antenna to the wireless device;
determining if the antenna identification code of the detachable antenna is a valid antenna identification code for the wireless device;
enabling operation of the wireless device if the antenna identification code of the detachable antenna is a valid antenna identification code for the wireless device;
determining if the antenna identification code of the detachable antenna has been previously used by another wireless device; and
disabling operation of the wireless device if the antenna identification code of the detachable antenna has been used by another wireless device.

16. A system for validating a detachable antenna, the system comprising:
a detachable antenna comprising an antenna identification code; and
a wireless device comprising a controller, the controller to enable operation of the wireless device if the antenna identification code of the detachable antenna is a valid antenna identification code for the wireless device.

17. The system of claim 16, wherein the detachable antenna further comprises a near field communication (NFC) target device comprising the antenna identification code of the detachable antenna.

18. The system of claim 16, wherein the wireless device further comprises a near field communication (NFC) initiator device coupled to the controller.

19. The system of claim 16, wherein the controller further comprises a comparator to compare the antenna identification code of the detachable antenna with a plurality of authorized antenna identification codes at the wireless device to determine if the antenna identification code of the detachable antenna is a valid identification code for the wireless device.

20. The system of claim 16, wherein the wireless device further comprises a user interface coupled to the controller.

21. The system of claim 16, further comprising a centralized database of authorized antenna identification codes, the centralized database of authorized antenna identification codes accessible by the wireless device and comprising a plurality of authorized antenna identification codes for the wireless device and a status identifier for each of the authorized antenna identification codes, the status identifier to identify the status of each of the authorized antenna identification codes as unused or previously used by another wireless device.

22. The system of claim 16, further comprising a certification authority accessible by the wireless device, the certification authority to identify the status of each of the digital certificates as unused or previously used by another wireless device.

23. The system of claim 16, wherein the wireless device is a wireless access point.
